(19) United States
(12) Patent Application Publication
(10) Pub. No.: US 2024/0100551 A1
(43) Pub. Date: Mar. 28, 2024

(54) BATTERY-POWERED SKID SPRAYER ASSEMBLY AND METHOD THEREOF

(71) Applicant: NORTHERN TOOL & EQUIPMENT COMPANY, INC., Burnsville, MN (US)

(72) Inventor: Matthew R. Pilcher, Owatonna, MN (US)

(21) Appl. No.: 18/471,423

(22) Filed: Sep. 21, 2023

Related U.S. Application Data
(60) Provisional application No. 63/410,457, filed on Sep. 27, 2022.

(51) Int. Cl. B05B 9/043; B05B 15/40; B05B 15/65

(52) U.S. Cl. CPC B05B 9/043; B05B 15/40; B05B 15/65

(57) ABSTRACT

A skid sprayer system includes a frame, a tank configured to hold a fluid, a hydraulic control system including a pump and a control valve, a hose fluidly coupled to the tank for dispensing the fluid, an electric motor operably coupled to the hydraulic pump, and a power module including a battery electrically coupled to the electric motor. The pump is operably driven by the electric motor. The pump comprises an input fluidly coupled to the tank and an outlet fluidly coupled to the hose.

### RELATED APPLICATIONS

This application claims the benefit of U.S. Provisional Patent Application Ser. No. 63/410,457, filed Sep. 27, 2022, the disclosure of which is hereby incorporated by reference in its entirety.

### FIELD OF THE DISCLOSURE

The present disclosure relates to a skid sprayer, and in particular, to a battery-powered skid sprayer.

### SUMMARY

In one implementation of the present disclosure, a skid sprayer system includes a frame, a tank configured to hold a fluid, a hydraulic control system including a pump and a control valve, a hose fluidly coupled to the tank for dispensing the fluid, an electric motor operably coupled to the hydraulic pump, and a power module including a battery electrically coupled to the electric motor. The pump is operably driven by the electric motor. The pump comprises an input fluidly coupled to the tank and an outlet fluidly coupled to the hose.

In one example of this implementation, the power module includes a controller electrically powered by the battery. In a second example, the power module includes a housing for enclosing the battery. In a third example, the power module includes a control interface including a battery charge level indicator, a charging port, and one or more controls. In a fourth example, the one or more controls includes a power control and a mode control. In a fifth example, the mode control includes an economy mode and a performance mode.

In a sixth example, the hydraulic control system includes an inlet fluid line, a bypass fluid line, and an output fluid line, wherein the inlet fluid line is fluidly coupled between the tank and the control valve, and the outlet fluid line is fluidly coupled between the control valve and the hose. In a seventh example, the control valve includes a first port fluidly coupled to the inlet fluid line, a second port fluidly coupled to the outlet fluid line, and a third port, the third port fluidly coupled to the bypass fluid line. In an eighth example, the bypass fluid line fluidly couples the control valve to the tank.

In another example, an agitation fluid line selectively fluidly coupled between the tank and the control valve. In a further example, an agitation valve is fluidly coupled to the agitation fluid line, the agitation valve being selectively controlled between an open position and a closed position.

In another implementation of the present disclosure, a skid sprayer system includes a frame having a first support member and a second support member, the frame being an open-style frame defining a first portion and a second portion. The system also includes a tank configured to hold a fluid, a hydraulic control system including a pump and a control valve, and a hose reel assembly coupled to the frame, the hose reel assembly including a hose fluidly coupled to the tank for dispensing the fluid. The skid sprayer system further includes a motor operably coupled to the hydraulic pump, and a power module including a battery electrically coupled to the electric motor. The pump is operably driven by the electric motor and includes an input fluidly coupled to the tank and an outlet fluidly coupled to the hose. The tank is arranged in the first portion, and at least the pump, the motor, and the hose reel assembly are arranged in the second portion.

In one example of this implementation, the tank is located between the first support member and the second support member. In a second example, the power module includes a controller electrically powered by the battery. In a third example, the power module includes a housing for enclosing the battery. In a fourth example, the power module includes a control interface including a battery charge level indicator, a charging port, and one or more controls.

In a fifth example, the hydraulic control system includes an inlet fluid line, a bypass fluid line, and an output fluid line, wherein the inlet fluid line is fluidly coupled between the tank and the control valve, and the outlet fluid line is fluidly coupled between the control valve and the hose. In another example, the bypass fluid line fluidly couples the control valve to the tank. In yet another example, the control valve includes a first port fluidly coupled to the inlet fluid line, a second port fluidly coupled to the outlet fluid line, and a third port, the third port fluidly coupled to the bypass fluid line. In a further example, an agitation fluid line is selectively fluidly coupled between the tank and the control valve, and an agitation valve fluidly coupled to the agitation fluid line, the agitation valve being selectively controlled between an open position and a closed position. In yet a further example, a filter is fluidly coupled between the tank and the pump, the filter configured to reduce an amount of dirt or debris from flowing from the tank to the pump, and a valve fluidly coupled between the tank and the filter, the valve configured to be disposed in an open configuration and a closed configuration, where in the open configuration, the valve allows flow between the tank and the filter, and where in the closed configuration, the valve prevents flow between the tank and the filter.

### BACKGROUND

Conventional sprayer assemblies are generally gas-powered and provide a means to pressurize fluid and deliver it to a spray nozzle for dispensing of the fluid. While these sprayers can be effective during operation, gas-powered sprayers tend to be noisy and difficult to transport. With time, fuel consumption of the gas-powered sprayers increases which is expensive, and which can be harmful to the environment.

Some non-gas powered conventional sprayers require electric cords which can be prohibitive for an effective spraying operation particularly when remote from common power sources. Further, electric corded sprayers may provide low power performance.

Thus, there is a desire for an improved skid sprayer which operates more cleanly than gas-powered sprayers. There is also a desire for an improved sprayer which does not require a cord to plug into a power source.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings, wherein:

FIG. 1 is a perspective view of a skid sprayer assembly;

FIG. 2 is a top perspective view of the skid sprayer assembly of FIG. 1;

FIG. 3 is a partial perspective view of the skid sprayer assembly of FIG. 1;

FIG. 4 is another perspective view of the skid sprayer assembly of FIG. 1 without the tank and some controls;

FIG. 5 is a perspective view of a battery for the skid sprayer assembly of FIG. 1;

FIG. 6 is a perspective view of a power module of the skid sprayer assembly of FIG. 1;

FIG. 7 is another perspective view of the power module of FIG. 6 in a second position;

FIG. 8 is a partial perspective view of a control panel of the power module of FIG. 6;

FIG. 9 is a top view of the skid sprayer assembly of FIG. 1; and

FIG. 10 is a perspective view of the skid sprayer assembly of FIG. 1 with some components removed.

Corresponding reference numerals are used to indicate corresponding parts throughout the several views.

### DETAILED DESCRIPTION

The implementations of the present disclosure described below are not intended to be exhaustive or to limit the disclosure to the precise forms disclosed in the following detailed description. Rather, the implementations are chosen and described so that others skilled in the art may appreciate and understand the principles and practices of the present disclosure.

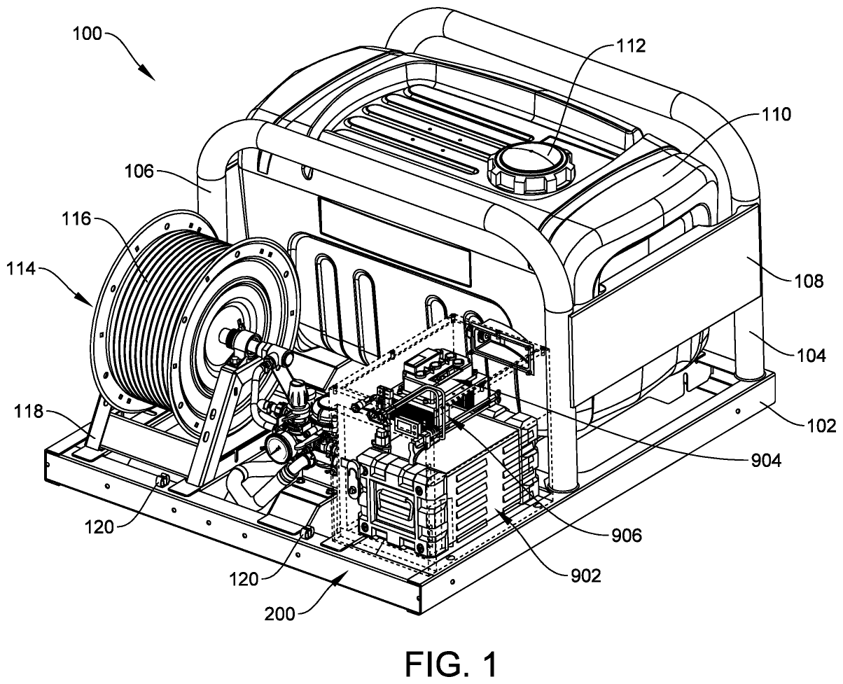

Referring to FIGS. 1-4, a skid sprayer assembly 100 is shown. The skid sprayer assembly 100 may be operably controlled for spraying a fluid which may be stored or contained in a tank 110. The tank 110 may be a 55 gallon tank in one i. In other implementations, the tank 110 may be smaller than 55 gallons. In yet other implementations, the tank 110 may be greater than 55 gallons. The tank 110 may be capable of storing any type of fluid for spraying. In one example, the fluid may be water. In another example, the fluid may be a pesticide. In a further example, the fluid may be a herbicide. In another example, the fluid may be air or other gas. For purposes of this disclosure, the term “fluid” is broadly interpreted to mean a gas, liquid, or combination thereof.

In one implementation, the skid sprayer assembly 100 may include a skid frame 102 as shown. The frame 102 may include a pair of U-shaped arms 104, 106 and a pair of cross members 108 which define a cavity for the tank 110 to be positioned. The tank 110 may include a cap 112 which is releasably secured to the tank 110. Upon removing the cap 112, fluid may be filled or removed from the tank 110.

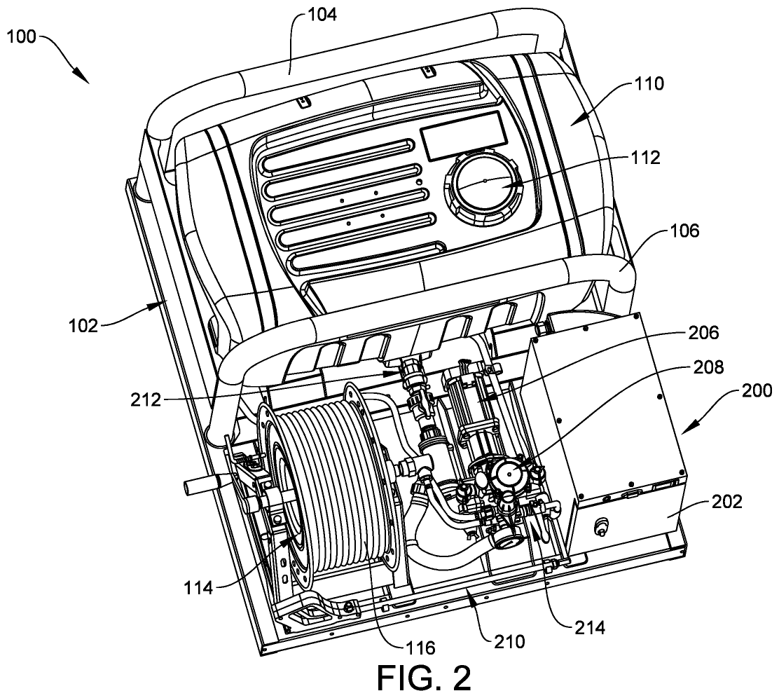

The tank 110 may include an outlet 212 which is fluidly coupled to a pump 208, as shown in FIG. 2. The pump 208 may be a hydraulic pump. In other implementations, the pump 208 may be an electric or other known type of pump. The pump 208 may have an inlet which is fluidly coupled to the outlet 212 of the tank 110. The pump 208 may be operably driven via a motor 206. The motor 206 may be an electric motor in one implementation. The motor 206 may electrically power the pump 208 to suction fluid from the outlet 212 of the tank 110 and deliver pressurized fluid to a control valve 214. The control valve 214 may control the flow of fluid to one or more fluid lines.

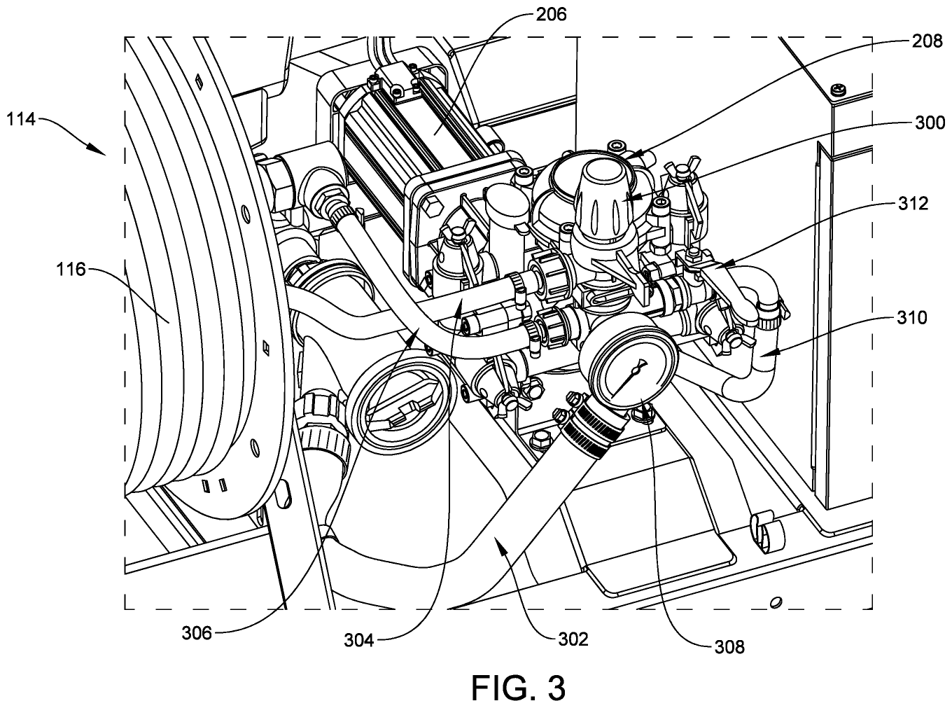

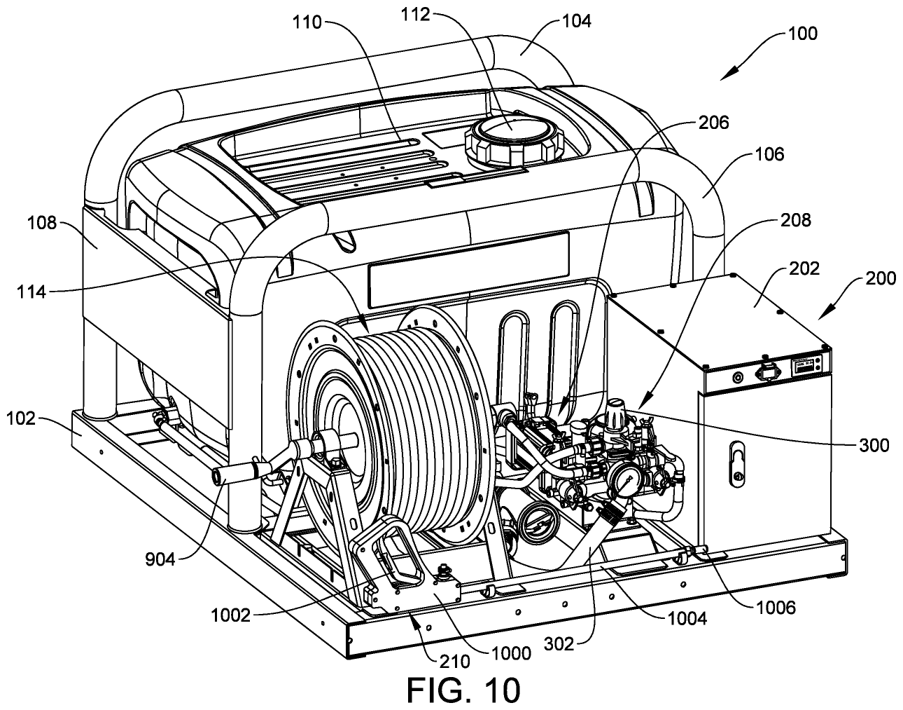

In FIG. 3, for example, an inlet line 302 may supply fluid from the tank 110 to the pump 208. In turn, pressurized fluid from the pump 208 may be delivered to the control valve 214 where an output line 306, a bypass line 304, and an agitation line 310 are fluidly coupled. The output line 306 may be fluidly coupled to a hose 116 of a hose reel assembly 114 coupled to the skid frame 102. The hose reel assembly 114 may be mounted or removably coupled to the skid frame 102 via a support frame 118. The hose 116 may be coupled to a spray wand or gun assembly 210 having a flow nozzle 1006 (see FIG. 10). An operator may use the spray wand or gun for performing a spraying function.

The spray wand or spray gun assembly 210 may include an interchangeably, removable nozzle 1006. The nozzle 1006 may be selectively coupled to a wand or elongate member 1004 of the spray gun assembly 210. The selection of the nozzle 1006 may be from a plurality of nozzles capable of outputting different spray patterns, flow velocities, and the like. The spray gun assembly 210 may include a handle 1000 having a trigger 1002 for fluidly discharging fluid through the elongate member 1004 and nozzle 1006. The elongate member 1004 may be removably coupled to the handle 1000 via a screw fit connection, a snap-fit connection, or other type of connection. In some implementations, the elongate member 1004 may be integrally formed as part of the handle 1000. As shown in FIG. 1, one or more couplers 120 may be connected to the skid frame 102. The spray gun assembly 210 may be removably coupled to the skid frame 102 via the one or more couplers 120.

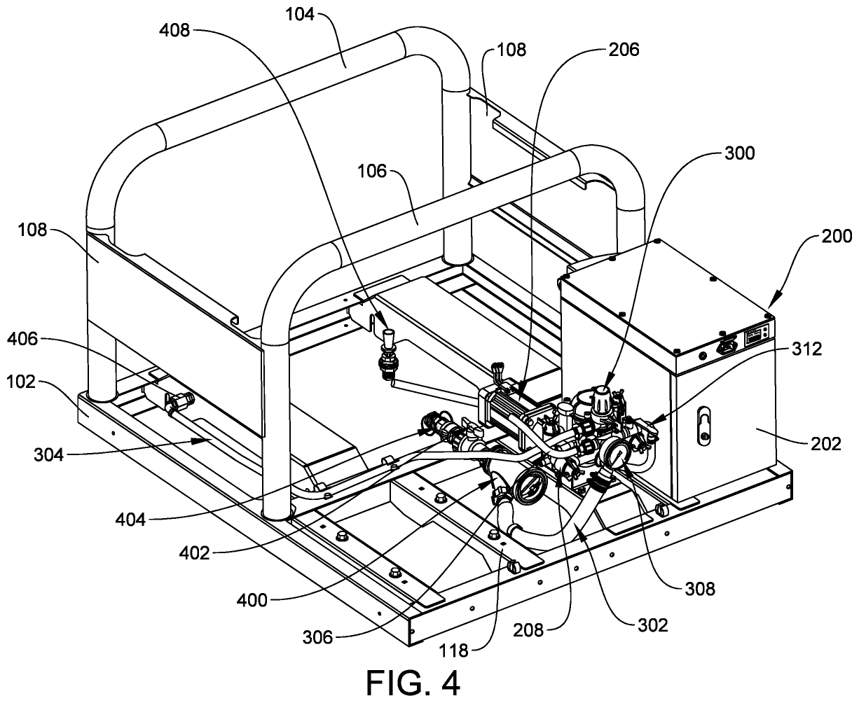

The bypass line 304 may be fluidly coupled to the control valve 214 in which pressurized fluid may be returned to the tank 110 or pump 208 in some operating conditions. A fluid coupler 406 shown in FIG. 4 illustrates the connection between the bypass line 304 and the tank 110.

The control valve 214 may include a regulator 300 for regulating fluid pressure in the system as shown in FIG. 3. The control valve 214 may be operably controlled to control which of one or more operating conditions the sprayer assembly 100 is to function in.

An agitation line 310 may also be fluidly coupled to the control valve 214. The agitation line 310 may include a ball valve 312 in the line which may be operably controlled to fully or partially open or close the agitation line 310. The agitation line 310 may return pressurized fluid to the tank 110 to agitate or mix the fluid in the tank 110 to prevent any portion of the fluid from settling. In other implementations, the agitation line 310 may be fluidly coupled to other lines in the system to avoid product settling. The agitation line 310 may include a valve 312 such as a ball valve. The valve 312 may be controllably opened or closed to fluidly couple or decouple the agitation line 310 to the tank 110. When the valve 312 is open, fluid may flow into the tank 110 via the agitation line 310. When the valve 312 is closed, fluid is blocked from flowing into the tank 110 via the agitation line 310.

Referring to FIG. 4, the system 100 may include an eductor nozzle 408 for agitating the fluid in the tank 110. The eductor nozzle 408 may be fluidly coupled to the agitation line 310. The system 100 may also include one or more couplings 404, a ball valve 402, and a strainer 400 as shown in FIG. 4. These features may control the flow of fluid to the pump 208 from the tank 110. Moreover, one or more of these features may filter or remove any debris that may otherwise impact the function of the system 100 including the pump 208. In particular, in one implementation, the strainer 400 may function as a filter to preclude dirt, debris and other particulates from being suctioned into the pump 208. The couplings 404 may assist with coupling the outlet 212 of the tank 110 to the inlet line 302 to the pump 208.

The skid sprayer assembly 100 may include one or more sensors for detecting or measuring flow or operating characteristics of the system. In FIG. 3, for example, a pressure gauge 308 is shown. Other sensors such as flow sensors, pressure sensors, and the like may be incorporated in the system 100. The pressure gauge or sensor 308 may provide detection of the system 100

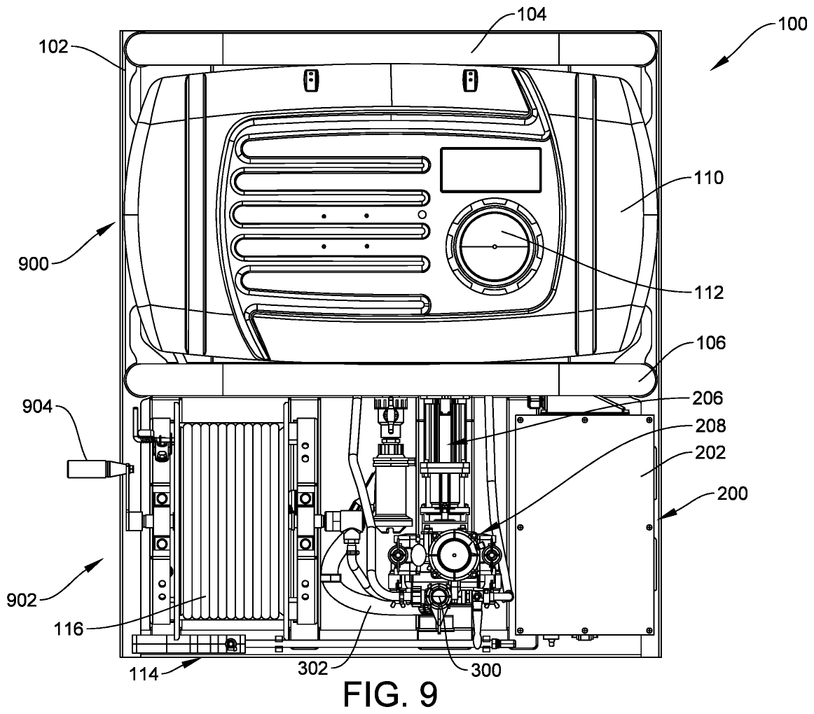

As shown in FIG. 9, the system 100 is arranged as a first portion 900 and a second portion 902. The tank 110 is coupled to the first portion 900 of the system 100. The hose reel assembly 114, the pump 208, the motor 206, the control valve 214, strainer 400, and fluid lines are located in the second portion 902 of the system. The frame 102 is largely an open-style frame, i.e., there is no side panels or top panel that encloses the first and second portions. The tank 110 is located between the first support member 104 and the second support member 106.

The hose reel assembly 114 is shown including a handle 904 in FIG. 9 for reeling the hose 116 from an unreeled position to a reeled position. The reeled position is shown in FIG. 9.

While the implementation of FIGS. 1-4 illustrates a hydraulic control system including a tank 110, a hydraulic pump 208, and a hydraulic control or regulator valve 214, in other implementations the skid sprayer assembly 100 may be an electrically driven system whereby the entire assembly is electrically driven.

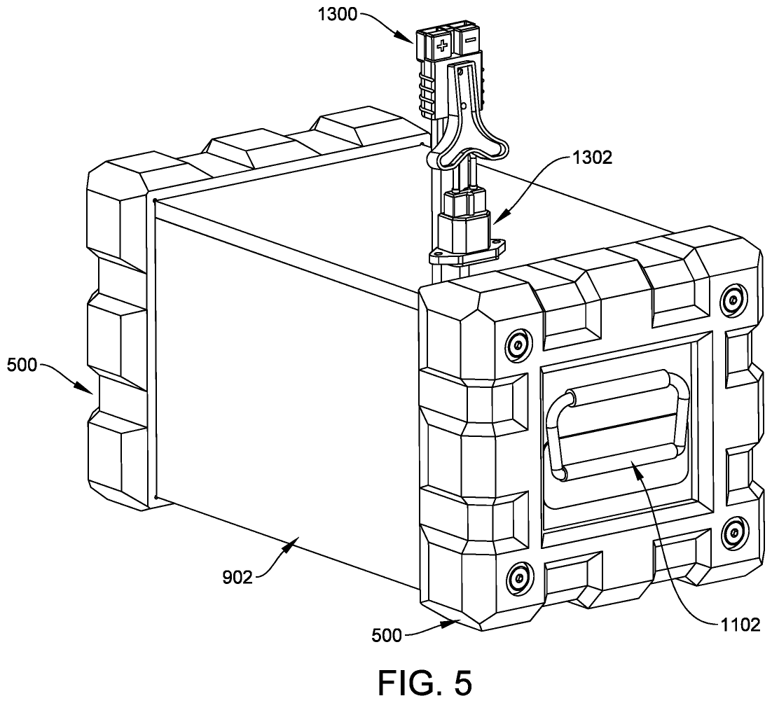

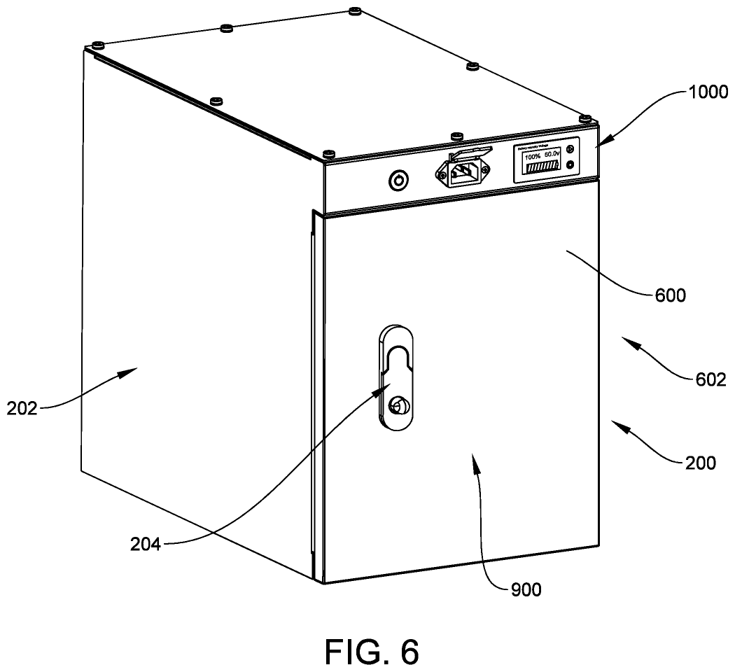

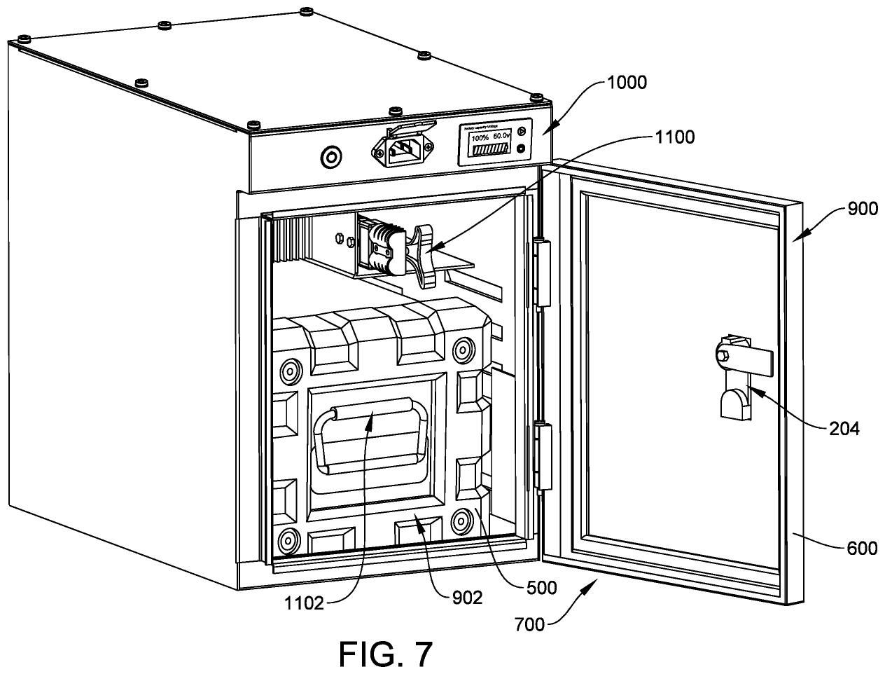

In FIGS. 5-10 of the present disclosure, the skid sprayer assembly 100 may include a power module 200. The power module 200 may comprise an outer housing 202 or casing with a latch assembly 204 for releasably latching a door assembly 600 (see FIG. 6) in a closed position 602 to the housing 202. The door assembly 600 may include a door 900 and hinges (not shown) for selectively manipulating the door 900 between the closed position 602 to an open position 700 as shown in FIG. 7. The latch assembly 204 may facilitate holding the door 900 in the closed position 602. The power module 200 will be described in further detail below.

The skid sprayer assembly 100 may be battery-powered to help conserve energy and operate the assembly in a cleaner, more environmentally-friendly manner. A typical gas engine may be replaced by an electric motor 206 as shown in FIG. 2. The electric motor 206 may be electrically powered via a battery 902 which is shown disposed in the outer housing 202. In one implementation, the door 900 may seal the interior of the housing 202 from dirt, dust and other contaminants.

A controller 904 may also be located in the housing 202 at a location adjacent the battery 902. The controller 904 may be powered by the battery 902. A heat sink or other cooling mechanism 906 may be provided to help cool or regulate the temperature of the battery 902 and controller 904. The power module 200 may include a control panel or interface 1000 as shown in FIG. 6. A battery connection terminal 1100 may also be provided as part of the power module 200. The battery 902 may include a handle 1102 to allow it to be removed or positioned within the outer housing 202 more easily. One or more connectors including a first connector 1300 and a second connector 1302 may extend from the battery 902 for coupling to the controller 904, a battery meter 1204 or charge indicator, and a charger. Further, as shown in FIG. 5, an endcap 500 may be placed on each of at least two sides of the battery 902. The endcap 500 may be formed of rubber, plastic, or other material. The endcap 500 may preclude movement of the battery 902 in the housing 202. The endcap 500 may also be formed of a material to help ground the battery.

The control panel or interface 1000 may include a plurality of controls for controlling the performance of the skid sprayer assembly 100. A first control 1200 may include a master or main power control. The first control 1200 may determine if the battery 902 outputs any electrical power to the controller 904, battery meter 1204, motor, etc. An operator may disable the battery 902 by triggering the first control 1200.

The control panel or interface 1000 may also include a second control 1202 for enabling or disabling an economy mode of the skid sprayer assembly 100. The skid sprayer assembly 100 may go unused for periods of time. If the second control 1202 is enabled, the controller 904 may operably shutdown the power from the battery 902 to the electric motor to conserve the battery 902. In some instances, software may be stored or written in the controller 904 for performing this task automatically regardless of whether the second control is enabled. In other instances, if the second control 1202 is disabled, then the controller 904 may not shutdown the battery 902 until the second control 1202 is enabled.

The control panel or interface 1000 may include a battery charge level indicator 1204. A sensor (not shown) may be coupled to the battery 902 for detecting its charge status. The charge status may be communicated to the control panel via the indicator 1204. The sensor may be in communication with the controller 904 which in turn outputs the charge level via the indicator 1204.

A charging port 1206 may be provided on the control panel or interface 1000. In one implementation, the charging port 1206 may be configured to allow the battery 902 to be charged without having to remove it from the power module 200. A charger (not shown) may be coupled to the charging port 1206 to facilitate the charging or re-charging of the battery 902. In an alternative implementation, other electrically-powered devices may run off the battery power by connecting to the charging port 1206 or to another port not shown. The control panel may also display other information related to battery performance, motor performance, controller performance and the like.

A control system for controlling a skid sprayer assembly may include a controller having a memory unit and a processor. The memory unit may be capable of storing control logic, software, algorithms, look up tables, a set of instructions, and the like. The processor may be capable of executing the control logic, software, algorithms, look up tables, set of instructions, etc. stored by the memory unit. In some implementations, the controller may be similar or the same as the controller 904.

The controller may be electrically powered by a battery. The battery may be similar or the same as the battery 902. A charge sensor may form part of the control system capable of detecting a current charge status of the battery. The sensor may be in communication with the controller for providing the current charge status of the battery. The controller may be in communication with a control panel such as the control panel 1000 where it is able to display or otherwise communicate the current charge status of the battery to an operator or user.

In some implementations, the controller may be in communication with a transmitter (not shown) over a wireless network such as Wi-Fi or the like. The controller may be able to communicate to a remote device such as a cell phone, tablet, laptop, or other computer system via the transmitter and wireless network. In doing so, the controller may be able to communicate the battery charge status and other details about the control system or the functioning of the skid sprayer assembly 100. Other sensors may detect performance characteristics of the skid sprayer assembly including performance of the hydraulic pump, electric motor, and operation of the control valve, hydraulic actuator, etc. These performance characteristics may be communicated to the controller which in turn may communicate these characteristics to the control panel or to a remote device over the wireless network. In several implementations, a user may have an application on their remote device which receives communications from the controller regarding charge status, performance characteristics, and the like.

The control system may include a charging port similar to the charging port 1206. The charging port may be used for coupling to another charge supply device for charging or re-charging the battery. In other implementations, the charging port may be configured for charging another electronic device or provide electrical power to operate another device such as a saw, trimmer, etc.

A power switch may be provided as part of the control system for energizing or de-energizing the controller and other components. A user may trigger the power switch to allow the controller and electric motor to receive electrical power from the battery.

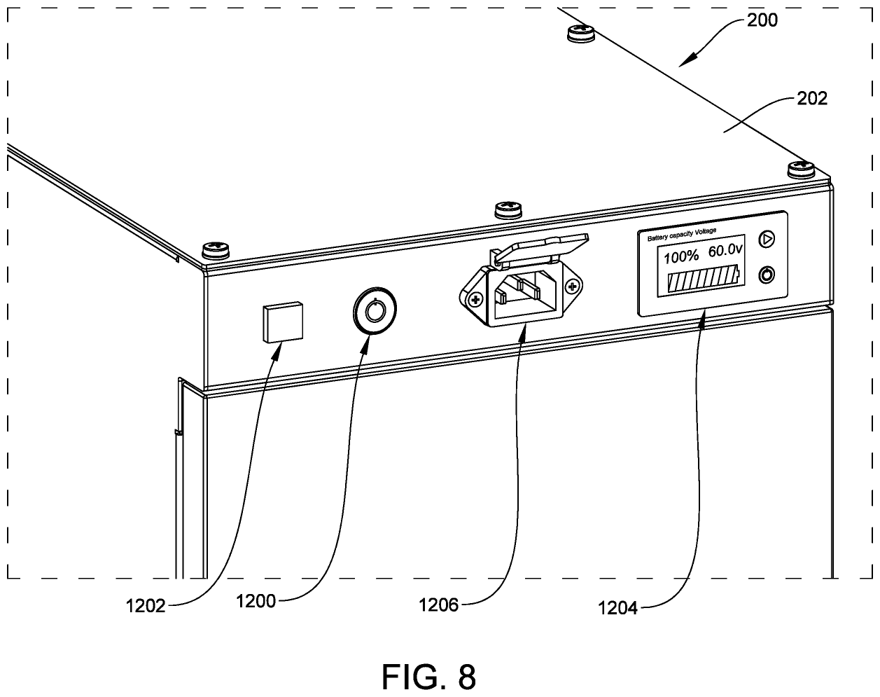

The control system may also include an economy mode switch similar to or the same as the switch 1202 in FIG. 8. The economy mode switch may be on the control panel or it may be remote therefrom. In some implementations, a user may have an application on a remote device such as a cell phone where they can trigger the power switch and economy mode switch remote from the assembly 100.

While exemplary implementations incorporating the principles of the present disclosure have been disclosed hereinabove, the present disclosure is not limited to the disclosed implementations. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A skid sprayer system, comprising:
a frame;
a tank configured to hold a fluid;
a hydraulic control system including a pump and a control valve;
a hose fluidly coupled to the tank for dispensing the fluid;
an electric motor operably coupled to the hydraulic pump; and
a power module comprising a battery electrically coupled to the electric motor;
wherein, the pump is operably driven by the electric motor;
wherein, the pump comprises an input fluidly coupled to the tank and an outlet fluidly coupled to the hose.

2. The skid sprayer system of claim 1, wherein the power module comprises a controller electrically powered by the battery.

3. The skid sprayer system of claim 2, wherein the power module comprises a housing for enclosing the battery.

4. The skid sprayer system of claim 3, wherein the power module comprises a control interface including a battery charge level indicator, a charging port, and one or more controls.

5. The skid sprayer system of claim 1, wherein the hydraulic control system comprises an inlet fluid line, a bypass fluid line, and an output fluid line;
wherein the inlet fluid line is fluidly coupled between the tank and the control valve, and the outlet fluid line is fluidly coupled between the control valve and the hose.

6. The skid sprayer system of claim 5, wherein the control valve comprises a first port fluidly coupled to the inlet fluid line, a second port fluidly coupled to the outlet fluid line, and a third port, the third port fluidly coupled to the bypass fluid line.

7. The skid sprayer system of claim 6, wherein the bypass fluid line fluidly couples the control valve to the tank.

8. The skid sprayer system of claim 5, further comprising an agitation fluid line selectively fluidly coupled between the tank and the control valve.

9. The skid sprayer system of claim 8, further comprising an agitation valve fluidly coupled to the agitation fluid line, the agitation valve being selectively controlled between an open position and a closed position.

10. A skid sprayer system, comprising:
a frame comprising a first support member and a second support member, the frame being an open-style frame defining a first portion and a second portion;
a tank configured to hold a fluid;
a hydraulic control system including a pump and a control valve;
a hose reel assembly coupled to the frame, the hose reel assembly comprising a hose fluidly coupled to the tank for dispensing the fluid;
a motor operably coupled to the hydraulic pump; and
a power module comprising a battery electrically coupled to the electric motor;
wherein, the pump is operably driven by the electric motor;
wherein, the pump comprises an input fluidly coupled to the tank and an outlet fluidly coupled to the hose;
wherein, the tank is arranged in the first portion, and at least the pump, the motor, and the hose reel assembly are arranged in the second portion.

11. The skid sprayer system of claim 10, wherein the tank is located between the first support member and the second support member.

12. The skid sprayer system of claim 10, wherein the power module comprises a controller electrically powered by the battery.

13. The skid sprayer system of claim 12, wherein the power module comprises a housing for enclosing the battery.

14. The skid sprayer system of claim 13, wherein the power module comprises a control interface including a battery charge level indicator, a charging port, and one or more controls.

15. The skid sprayer system of claim 10, wherein the hydraulic control system comprises an inlet fluid line, a bypass fluid line, and an output fluid line;
wherein the inlet fluid line is fluidly coupled between the tank and the control valve, and the outlet fluid line is fluidly coupled between the control valve and the hose;
wherein the bypass fluid line fluidly couples the control valve to the tank.

16. The skid sprayer system of claim 15, wherein the control valve comprises a first port fluidly coupled to the inlet fluid line, a second port fluidly coupled to the outlet fluid line, and a third port, the third port fluidly coupled to the bypass fluid line.

17. The skid sprayer system of claim 15, further comprising:
an agitation fluid line selectively fluidly coupled between the tank and the control valve;
an agitation valve fluidly coupled to the agitation fluid line, the agitation valve being selectively controlled between an open position and a closed position.

18. The skid sprayer system of claim 15, further comprising:
a filter fluidly coupled between the tank and the pump, the filter configured to reduce an amount of dirt or debris from flowing from the tank to the pump; and
a valve fluidly coupled between the tank and the filter, the valve configured to be disposed in an open configuration and a closed configuration;
wherein, in the open configuration, the valve allows flow between the tank and the filter;
wherein, in the closed configuration, the valve prevents flow between the tank and the filter.
